(19) United States
(12) Patent Application Publication
(10) Pub. No.: US 2015/0277485 A1
(43) Pub. Date: Oct. 1, 2015

(54) INPUT DEVICE AND DISPLAY DEVICE

(71) Applicant: Panasonic Intellectual Property Management Co., Ltd., Osaka (JP)

(72) Inventors: Naoki KOSUGI, Kyoto (JP); Akira TOKAI, Hyogo (JP); Hiroyuki KADO, Osaka (JP); Takashi KITADA, Osaka (JP); Yutaka HISAMOTO, Hyogo (JP); Hiroaki KATO, Osaka (JP)

(21) Appl. No.: 14/666,704

(22) Filed: Mar. 24, 2015

(30) Foreign Application Priority Data
Mar. 26, 2014 (JP) 2014-063501
Nov. 6, 2014 (JP) 2014-226018

(51) Int. Cl. G06F 1/16; G06F 3/044; G06F 3/041; G02F 1/1333

(52) U.S. Cl. CPC G06F 1/16; G02F 1/13338; G06F 3/044; G06F 3/0412; G06F 3/0416; G06F 2203/04112; G06F 2203/04103

(57) ABSTRACT

In an input device, first electrodes are arranged on a first transparent substrate, and second electrodes are arranged on a second transparent substrate coupled to the first transparent with second electrodes intersecting with first electrodes. A control unit detects electrostatic capacitance. The first transparent substrate includes a first joint region where the no first electrodes are arranged and a plurality of regions into which a whole region of the first transparent substrate is segmented by the first joint region. The second transparent substrate includes a second joint region where no second electrodes are arranged and a plurality of regions into which a whole region of the second transparent substrate is segmented by the second joint region. On the coupled transparent substrates, the first and second joint regions are arranged such that the first joint region and the second joint region do not overlap with each other partially or wholly.

### BACKGROUND

1. Technical Field

Present disclosure relates to an input device for inputting coordinates to a screen, and a display device provided with an input device.

2. Related Art

Recently, the utilization of an electronic board has been proposed to enhance information and communication technology in the field of education and the management of conferences in enterprises. The electronic board is a display device which is the combination of an image display device such as a smart phone or a tablet PC and an input device such as a touch panel or a touch pen. As electronic boards which have been put on a market, recently, there have been developed products having a screen size exceeding 70 inches such that a large number of users can simultaneously operate the electronic board.

As an input device for realizing an electronic board, usually an optical sensor type touch panel is adopted. On the other hand, there has been a demand an electrostatic capacitance type touch panel is adopted for an input device of an electronic board since it has the simpler structure and higher inputting accuracy than the optical sensor type touch panel.

Further, with respect to a display device having a touch sensor function such as the electronic board, there has been a demand for a large-sized display device with a low cost of manufacturing. To satisfy such a demand, the development of a multi display which is constituted by arranging a plurality of small-sized display devices or panels has been progressed. For example, JP 2013-45150 A discloses a display device where a plurality of touch panels are arranged such that the touch panels partially overlap with each other.

### SUMMARY

It is an object of present disclosure to provide an input device which can be used integrally with a display device, and can be easily upsized in manufacturing.

According to one aspect of the present disclosure, there is provided an input device which includes a first transparent substrate, a second transparent substrate, and a control unit. On the first transparent substrate, a plurality of first electrodes are arranged. On the second transparent substrate, a plurality of second electrodes are arranged so that the second electrodes intersect with the first electrodes. The second transparent substrate is coupled to the first transparent substrate with the first and second transparent substrates overlapping with each other. The control unit is configured to by detect electrostatic capacitance between the first and second electrodes to detect coordinates of touch points on the first and second transparent substrates coupled to each other. The first transparent substrate includes a first joint region on which the first electrodes are not arranged and a plurality of regions into which a whole region of the second transparent substrate is segmented by the first joint region, each segmented region having the plurality of first electrodes arranged thereon. The second transparent substrate includes a second joint region on which the second electrodes are not arranged and a plurality of regions into which a whole region of the first transparent substrate is segmented by the second joint region, each segmented region having the plurality of second electrodes are arranged. On the coupled first and second transparent substrates, the first and second joint regions are arranged such that the first joint region and the second joint region do not overlap with each other partially or wholly.

The display device according to present disclosure includes the input device and a display unit having a display screen to display an image. The first and second transparent substrates of the input device are joined to the display unit in an overlapping manner with the display screen.

According to another aspect of the present disclosure, there is provided a method of manufacturing an input device. In the method, a plurality of first electrodes are formed on a first transparent substrate by using a first exposure mask formed by joining a plurality of exposure masks on a first joint portion. A plurality of second electrodes are formed on a second transparent substrate by using a second exposure mask formed by joining a plurality of exposure masks at a second joint portion. The first transparent substrate and the second transparent substrate are laminated to each other with the first electrodes intersecting with the second electrodes. In the laminating the first transparent substrate and the second transparent substrate, the first transparent substrate and the second transparent substrate are laminated to each other so that a first joint region where the first electrodes are not arranged corresponding to the first joint portion on the first transparent substrate does not overlap, partially or wholly, with a second joint region where the second electrodes are not arranged corresponding to the second joint portion on the second transparent substrate.

According to the input device of present disclosure, each electrode can be formed in every region defined by joints and hence, a large-sized input device can be easily manufactured.

### BRIEF DESCRIPTION OF DRAWINGS

FIG. 1 is a schematic view showing the constitution of a liquid crystal display device according to a first embodiment;

FIG. 2 is a cross-sectional view of an input device of the liquid crystal display device taken along a line A-A;

FIG. 3 is a view for describing the arrangement of electrodes of the input device.

FIG. 4 is a view showing one example of an exposure mask for detection electrodes;

FIG. 5 is a view showing an arrangement example of detection electrodes formed by the exposure mask shown in FIG. 4;

FIG. 6 is a view showing one example of an exposure mask for drive electrodes;

FIG. 7 is a view showing an arrangement example of the drive electrodes formed by the exposure mask shown in FIG. 6;

FIG. 8 is a view showing one example of a transparent substrate film having detection electrodes according to a second embodiment;

FIG. 9 is a view showing one example of a transparent substrate film having drive electrodes;

FIG. 10 is a view for describing an arrangement of electrodes of an input device;

FIGS. 11A and 11B are views showing one example of an exposure mask according to another embodiment;

FIG. 12A to FIG. 12C are views showing one example of a pattern of electrodes of an input device; and

FIG. 13 is a view showing one example of a pattern of dummy electrodes.

### DETAILED DESCRIPTION

Hereinafter, an embodiment is described in detail while referring to the drawings as appropriate. However, detailed descriptions are sometimes omitted when they are not required. For example, detailed descriptions of already well-known matters and repeated descriptions of substantially identical configurations are sometimes omitted. This has been done in order to avoid the following description from becoming unnecessarily redundant, and to facilitate understanding for persons skilled in the art.

It should be noted that the inventor(s) has provided the appended drawings and the following description in order for persons skilled in the art to sufficiently understand the present disclosure, not with the intention of thereby restricting the subject described in the claims.

### First Embodiment

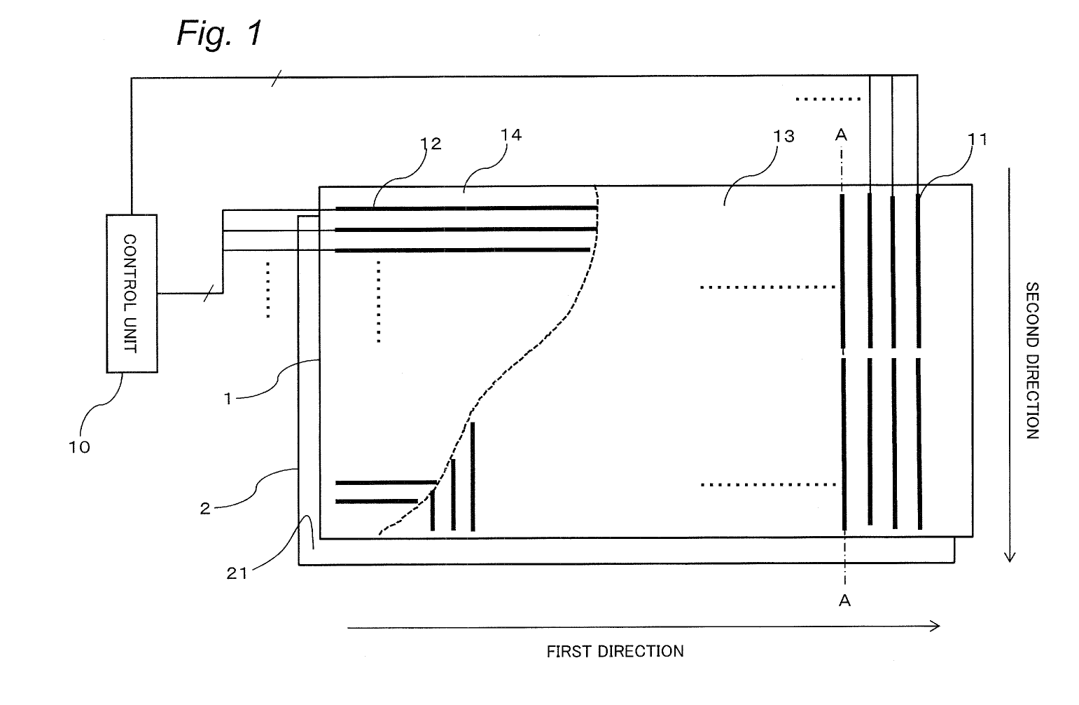

Hereinafter, the first embodiment is described with reference to FIG. 1 to FIG. 7.

### 1-1. Overview

Recently, there has been a demand for providing a large-sized electronic board at a low cost. An electronic board is constituted by combining a display device where a diagonal length of a screen exceeds 50 inches and an input device such as a touch panel, for example.

The touch panel includes electrodes for detecting coordinates of touch points on the screen of the display device. The electrodes for detecting coordinates of touch points are arranged on the screen of the display device. When the arrangement of the electrodes for detecting coordinates of touch points is partially non-uniform, visibility of the screen may degrade. For example, when the arrangement pitch of the electrodes is widened at some places on the screen, human eyes are extremely sensitive to such non-uniformity of the arrangement pitch.

In order to ensure the uniformity of the arrangement of electrode pattern within the screen, an exposure mask used for a photolithography method in a manufacturing process of the display device is conventionally chosen to be a single one-sheet-type exposure mask where electrodes are arranged uniformly on the whole surface of a touch panel. In this case, it is necessary to set the size of the exposure mask at least substantially equal to the size of a touch panel to be manufactured. Accordingly, when a large-sized touch panel having a diagonal length exceeding 50 inches is manufactured for use in an electronic board, a manufacturing cost of the exposure mask becomes extremely high. Consequently, a manufacturing cost of a large-sized display device with such a touch panel also becomes high.

Therefore, according to one aspect of the present disclosure, there is provided an input device which can decrease a manufacturing cost of a display device. Specifically, in place of a single large sheet of expensive exposure mask, a plurality of small-sized exposure masks are used in manufacturing a large-sized input device with these small-sized exposure masks joined to each other. A drawback of the visibility may arise from joints formed between the exposure masks. However, the input device and the display device according to this embodiment can also overcome such a drawback.

### 1-2. Configuration

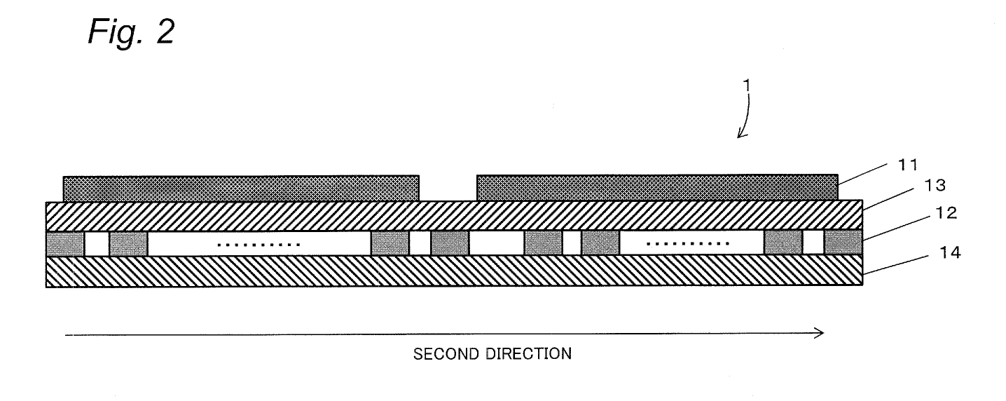

FIG. 1 is a schematic view showing the constitution of a liquid crystal display device according to the first embodiment. FIG. 2 is a cross-sectional view of an input device 1 in FIG. 1 taken along a line A-A. The liquid crystal display device is one example of a type of display device which is used integrally with an input device.

The liquid crystal display device includes an input device 1 and a display unit 2. The display unit 2 is configured by a liquid crystal display, and displays images and characters on a display screen 21. The input device 1 is arranged on a user side of the display unit 2 by overlapping with the display screen 21 of the display unit 2. The input device 1 has a touch sensor function of detecting input operation by a touch (contact). The input device 1 has high transparency such that an image displayed on the display screen 21 can be visually recognized from a user side of the display unit 2. A user can perform a touch operation which conforms to an image displayed on the display screen 21 by touching the input device 1.

The input device 1 is an electrostatic capacitance coupling-type touch panel including plural pairs of electrostatic capacitance detection electrodes, wherein each pair of electrostatic capacitance detection electrodes are substantially orthogonal to each other and face each other with a dielectric element interposing therebetween. The input device 1 includes a transparent substrate film 13, a transparent substrate film 14, and a control unit 10. A plurality of detection electrodes 11 which are first electrodes for detecting electrostatic capacitance are arranged on the transparent substrate film 13. Drive electrodes 12 which are second electrodes for detecting electrostatic capacitance are arranged on the transparent substrate film 14. The transparent substrate film 13 is one example of the first transparent substrate, and the transparent substrate film 14 is one example of the second transparent substrate.

As shown in FIG. 1, the plurality of detection electrodes 11 are arranged on the transparent substrate film 13 parallel to each in the first direction. Each detection electrode 11 is made of a metallic fine wire and extends in the second direction orthogonal to the first direction. Further, the plurality of drive electrodes 12 are arranged on the transparent substrate film 14 parallel to each other in the second direction such that the drive electrodes 12 intersect with the detection electrodes 11. Each drive electrode 12 is made of a metallic fine wire and extends in the first direction.

In this embodiment, a transparent resin film is used as a material of the transparent substrate films 13, 14. A material of the transparent resin film is required to have visible transmittance, mechanical strength, and electrically insulating property. According to the requirement, a material of the transparent resin film includes, for example, polycarbonate, an acrylic resin, polyethylene terephthalate, triacetylcellulose or the like in the form of a transparent resin film, a transparent resin plate or the like.

Taking into account easiness of etching, stability, adhesiveness with a transparent resin and the like, a material of the detection electrode 11 and the drive electrode 12 includes, for example, a metal film or the like made of silver, copper, aluminum, gold, nickel, stainless copper or the like. Further, as a material of the detection electrode 11 and the drive electrode 12, a conductive paste material, a carbon paste material or the like containing fine particles made of the above-mentioned metals can be used.

In the electrostatic capacitance type input device for the large-sized liquid crystal display device used as the electronic board or the like, it is necessary to lower a sheet resistance of an electrode sufficiently for ensuring a touch reaction speed. Further, it is desirable that the input device has high transparency as described above. Accordingly, there has been observed a tendency that electrodes are made of metallic fine wires and arranged on a transparent resin film.

In production of the detection electrodes 11 and the drive electrodes 12, a photolithography method can be used. To be more specific, at first, a metal thin film is formed on the transparent substrate films 13, 14 (transparent resin film) respectively by sputtering, vapor deposition or stuck of metallic foils. Subsequently, a photoresist is applied to the metal thin film by coating. Next, a negative pattern of electrodes is transferred to the photoresist by performing exposure and developing through an exposure mask on which an electrode pattern is drawn. By etching the film to which the negative pattern of the electrodes is transferred and peeling off the photoresist, metallic fine wires are formed on the transparent resin film.

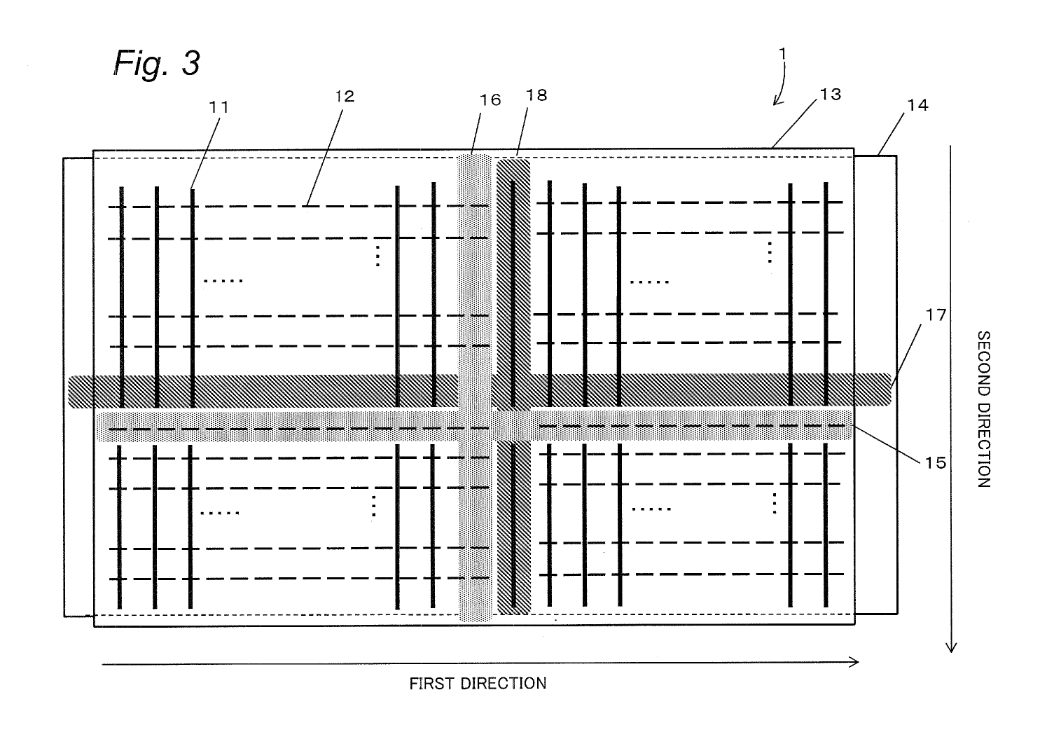

As shown in FIG. 2, in the input device 1, the transparent substrate film 13 on which the detection electrodes 11 are arranged and the transparent substrate film 14 on which the drive electrodes 12 are arranged are laminated to each other. Accordingly, the detection electrodes 11 and the drive electrodes 12 form capacitors by sandwiching therebetween the transparent substrate film 13 which is a dielectric element. The capacitors are located on the intersection between the detection electrodes 11 and the drive electrodes 12. That is, the plurality of capacitors are arranged in a matrix array (see FIG. 3).

Returning to FIG. 1, the control unit 10 controls the entire operation of the input device 1. The control unit 10 detects a change in electrostatic capacitance in each capacitor formed on the intersection between the detection electrode 11 and the drive electrode 12. To be more specific, at first, the control unit 10 supplies a drive signal to the respective drive electrodes 12 sequentially at a predetermined cycle. The control unit 10 detects electrostatic capacitances in the respective capacitors arranged in the matrix array by detecting a change in voltage of each one of the plurality of detection electrodes 11 in each cycle. By detecting electrostatic capacitances in the respective capacitors in response to a touch operation applied to the input device 1, the control unit 10 determines coordinates on the display screen 21 of the display unit 2 on which the input device 1 is arranged. The control unit 10 is formed of a semiconductor integrated circuit, for example.

FIG. 3 is a view for describing an arrangement of the electrodes of the input device 1. The joint regions in the input device 1 are described hereinafter with reference to FIG. 3.

In the input device 1 of this embodiment, the detection electrodes 11 and the drive electrodes 12 are formed by using a plurality of small-sized exposure masks which are joined to each other. In this manner, corresponding to the joint portions of the exposure masks, regions where no electrodes are arranged (joint regions) are formed on the transparent substrate films 13, 14 on which the electrodes 11, 12 are arranged. Such joint regions cause non-uniform arrangement of the electrodes, thus giving rise to a drawback that the non-uniform arrangement becomes conspicuous on the display screen. To cope with such a drawback, in this embodiment, by displacing the joint regions between two sheets of transparent substrate films from each other, the non-uniformity of the electrode arrangement can be made inconspicuous, thus maintaining visibility of the display screen.

In this embodiment, the transparent substrate film 13 of the input device 1 has joint regions 15, 16 where the detection electrodes 11 are not arranged. On the other hand, the transparent substrate film 14 has joint regions 17, 18 where the drive electrodes 12 are not arranged. The joint regions 15 to 18 are regions where the electrode pattern of the detection electrodes 11 or the drive electrodes 12 are not formed, according to the joint regions of the exposure masks described later and are regions. On the respective transparent substrate films 13, 14, the respective electrodes 11, 12 can be formed in every region segmented by the joint regions 15 to 18. By joining the small-sized exposure masks to each other with the use of the input device 1, the manufacture of the large-sized liquid crystal display device can be facilitated.

The joint region 15 is arranged such that the joint region 15 extends to both ends of the transparent substrate film 13 in the first direction and has a predetermined width. The joint region 16 is arranged such that the joint region 16 extends to both ends of the transparent substrate film 13 in the second direction and has a predetermined width. The joint regions 15, 16 respectively segment a whole region on the transparent substrate film 13 where the detection electrodes 11 are arranged. The joint regions 15, 16 are one example of the first joint regions.

The joint region 17 is arranged such that the joint region 17 extends to both ends of the transparent substrate film 14 in the first direction and has a predetermined width. The joint region 18 is arranged such that the joint region 18 extends to both ends of the transparent substrate film 14 in the second direction and has a predetermined width. The joint regions 17, 18 respectively segment a whole region on the transparent substrate film 14 where the drive electrodes 12 are arranged. The joint regions 17, 18 are one example of the second joint regions.

The transparent substrate films 13, 14 are laminated to each other with overlapping as shown in FIG. 3. On a region of the transparent substrate film 14 opposed to the joint regions 15, 16, the drive electrodes 12 are arranged. On a region of the transparent substrate film 13 opposed to the joint regions 17, 18, the detection electrodes 11 are arranged. In this manner, since there are the electrodes in regions on one transparent substrate film facing the joint regions of the other transparent substrate film, non-uniformity of the electrode pattern becomes inconspicuous.

### Exposure Mask

Hereinafter, the respective transparent substrate films 13, 14 and the exposure masks for forming electrodes on the respective transparent substrate films 13, 14 are described.

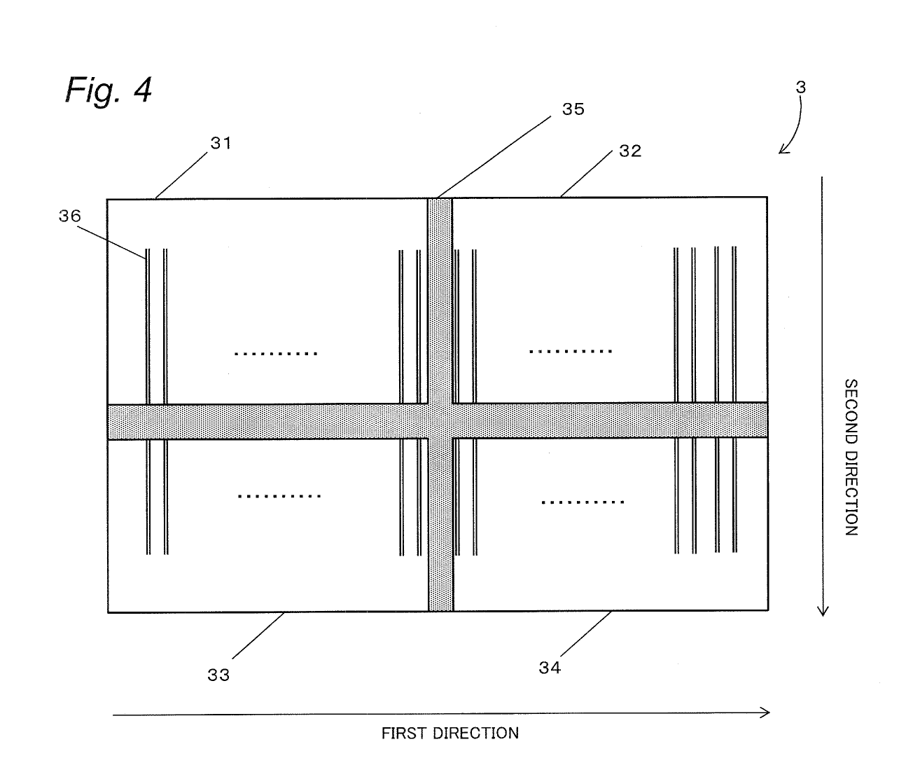

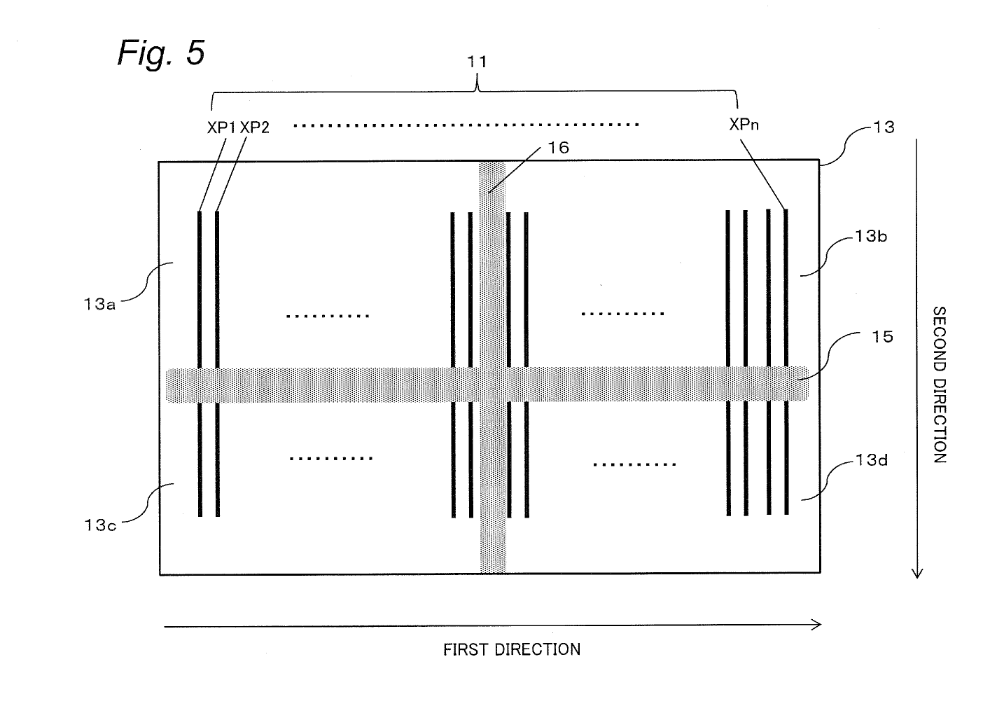

FIG. 4 is a view showing one example of exposure masks for detection electrodes used for manufacturing the detection electrodes 11. FIG. 5 is a view showing an arrangement example of the detection electrodes 11 formed by the exposure masks shown in FIG. 4.

In FIG. 4, an exposure mask 3 for detection electrodes includes four exposure masks 31 to 34. The respective exposure masks 31 to 34 are joined to each other at a joint region 35, thus forming a sheet of exposure mask. The exposure masks 31, 32, 33, 34 are exposure masks for forming the plurality of detection electrodes 11 which are arranged parallel to each other in the first direction, and have patterns 36 for forming the detection electrodes respectively. In the joint region 35 there is no pattern for forming electrodes by the exposure masks and hence, electrodes are not formed on a region of the transparent substrate film corresponding to the joint region 35. The joint region 35 is one example of the first joint region.

In the transparent substrate film 13 shown in FIG. 5, the plurality of detection electrodes 11 are formed by a photolithography method using the exposure mask 3 for detection electrode shown in FIG. 4. The plurality of detection electrodes 11 (XP1, XP2, . . . XPn) are arranged parallel to each other in the first direction on the transparent substrate film 13.

On the transparent substrate film 13, there are provided the joint region 15 which extends in the first direction and where the detection electrodes 11 are not arranged, and the joint region 16 which extends in the second direction and where the detection electrodes 11 are not arranged. The joint region 15 and the joint region 16 on the transparent substrate film 13 correspond to the joint region 35 on the exposure mask 3.

In respective regions 13a, 13b, 13c, 13d on the transparent substrate film 13 which are segmented by the joint regions 15, 16, the detection electrodes 11 are formed. In the respective regions 13a to 13d, the detection electrodes 11 are formed corresponding to the patterns 36 for forming detection electrodes of the exposure masks 31, 32, 33, 34. The respective detection electrodes 11 are arranged equidistantly at a predetermined pitch.

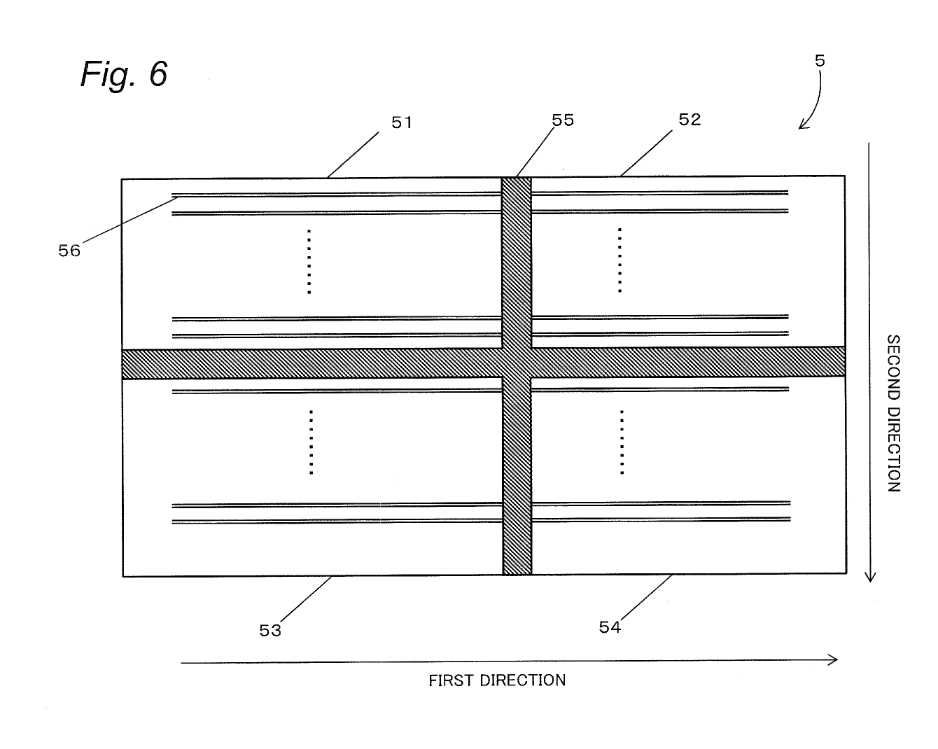

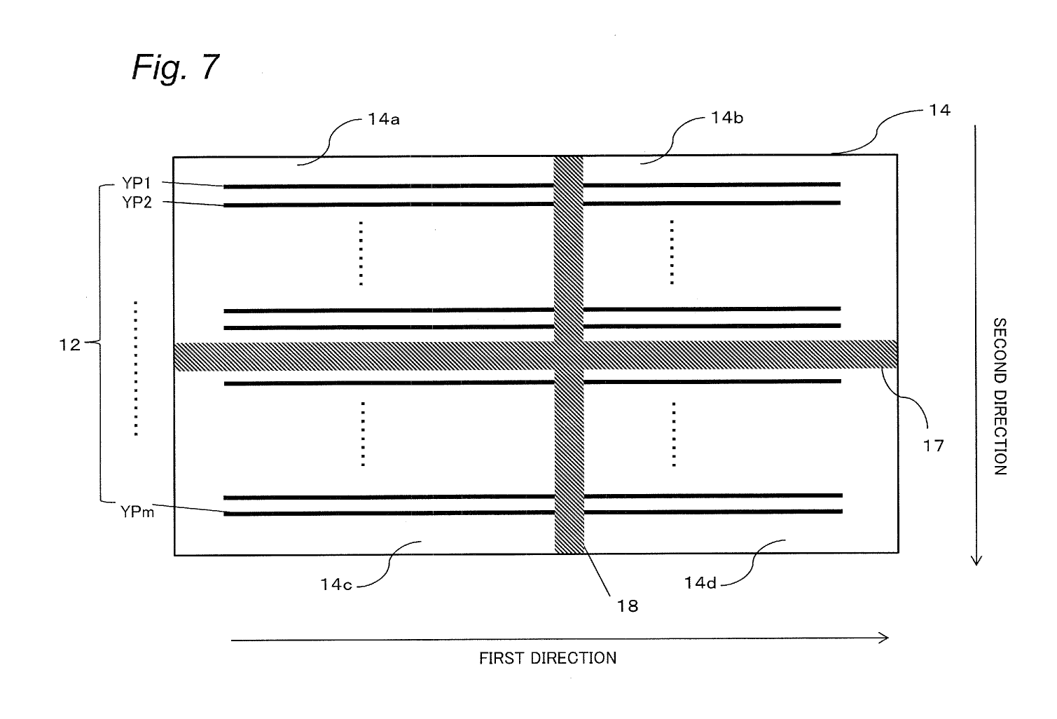

FIG. 6 is a view showing one example of an exposure mask used for forming the drive electrodes 12. FIG. 7 is a view showing an arrangement example of the drive electrodes 12 formed by the exposure mask shown in FIG. 6.

In FIG. 6, an exposure mask 5 for drive electrodes includes four exposure masks 51 to 54. Four exposure masks 51 to 54 are joined to each other at a joint region 55, thus forming one sheet of exposure mask. The exposure masks 51, 52, 53, 54 are exposure masks for manufacturing the plurality of drive electrodes 12 which are arranged parallel to each other in the second direction, and have patterns 56 for forming the drive electrodes respectively. In the joint region 55 there is no pattern for forming electrodes by the exposure masks and hence, electrodes are not formed on a region of the transparent substrate film corresponding to the joint region 55. The joint region 55 is one example of the second joint region.

The plurality of drive electrodes 12 shown in FIG. 7 are formed on the transparent substrate film 14 as pattern electrodes by a photolithography method using the exposure mask 5 for drive electrodes shown in FIG. 6. As shown in FIG. 7, the plurality of drive electrodes 12 (YP1, YP2, . . . YPm) are arranged parallel to each other in the second direction on the transparent substrate film 14.

On the transparent substrate film 14, there are provided the joint region 17 which extends in the first direction and in which drive electrodes 12 are not arranged, and the joint region 18 which extends in the second region and in which the drive electrodes 12 are not arranged. The joint region 17 and the joint region 18 correspond to joint portions 55 on the exposure mask 5.

In respective regions 14a, 14b, 14c, 14d on the transparent substrate film 14 which are segmented by the joint regions 17, 18, the drive electrodes 12 are formed. The drive electrodes 12 are formed corresponding to the patterns 56 for forming drive electrodes of the exposure masks 51, 52, 53, 54 respectively. The respective drive electrodes 12 are arranged equidistantly at a predetermined pitch.

As described above, a group of detection electrodes 11 and a group of drive electrodes 12 are formed on the transparent substrate films 13, 14, and thus generate the capacitors on the intersections therebetween. The control unit 10 detects a position (coordinates) on the display screen 21 in response to a touch operation by a user by detecting a change in electrostatic capacitance of the respective capacitors formed between the group of detection electrodes 11 and the group of drive electrodes 12 (see FIG. 1 and FIG. 3).

Hereinafter, an assembled state of the input device 1 is described. As shown in FIG. 3, the input device 1 is assembled by laminating the transparent substrate film 13 on which the detection electrodes 11 are arranged and the transparent substrate film 14 on which the drive electrodes 12 are arranged to each other. Here, the joint region 16 where the detection electrodes 11 are not arranged and the joint region 18 where the drive electrodes 12 are not arranged are displaced to positions in the first direction where the joint region 16 and the joint region 18 do not overlap with each other. To be more specific, on the laminated transparent substrate films 13, 14, positions of the joint regions 16, 18 in the first direction are set such that the joint regions 16, 18 are arranged adjacent to each other and parallel to the second direction. In the same manner, the joint region 15 where the detection electrodes 11 are not arranged and the joint region 17 where the drive electrodes are not arranged are displaced to positions in the second direction where the joint region 15 and the joint region 17 do not overlap with each other. To be more specific, with on the laminated transparent substrate films 13, 14, positions of the joint regions 15, 17 in the second direction are set such that the joint regions 15, 17 are arranged adjacent to each other and parallel to the first direction. That is, among the joint regions 15, 16 of the transparent substrate film 13 and the joint regions 17, 18 of the transparent substrate film 14, pairs of the regions extending in the same direction (the joint regions 15, 17, and the joint regions 16, 18) are formed with displacement so that the pairs of the regions extending in the same direction do not overlap with each other.

As described above, in the input device where two transparent substrates are laminated to each other, both the transparent substrate film for detection electrodes and the transparent substrate film for drive electrodes have the regions where the electrode pattern is non-uniform. In this embodiment, the regions of two transparent substrate films where the electrode patterns are non-uniform are displaced from each other. Due to such a constitution, at least one of the detection electrodes 11 and the drive electrodes 12 is observable from the user side over the substantially whole surface of the touch panel. Accordingly, even when the electrode are arranged non-uniformly due to the joint regions of the exposure masks, such non-uniformity can be made minimally visually recognized by human eyes. Due to such a constitution, it is possible to reduce a manufacturing cost of an exposure mask for forming electrodes while maintaining the visibility of the display screen.

In the transparent substrate films 13, 14, the joint regions 16, 18 and the joint regions 15, 17 respectively may not be arranged adjacent to each other. For example, the joint regions 16, 18 may be arranged across a number of the detection electrodes 11, e.g. one detection electrode 11 or two detection electrodes 11. The number of the detection electrodes 11 may be a non-integer number. Further, the joint regions 15, 17, for example, may be arranged across a number of the drive electrodes 12, e.g. one drive electrode 12 or two drive electrodes 12. The number of the drive electrodes 12 may be a non-integer number. Since insensible regions of the touch panel are dispersed by the arrangement of the joint regions across the electrodes, touch detection accuracy can be increased.

### Manufacturing Method

A manufacturing method of the input device 1 according to this embodiment is described.

At first, the plurality of detection electrodes 11 are formed on the transparent substrate film 13 by using the exposure mask 3 in which the plurality of exposure masks 31 to 34 for forming the detection electrodes 11 are joined to each other at the joint region 35 (see FIG. 4 and FIG. 5). On the other hand, the plurality of drive electrodes 12 are formed on the transparent substrate film 14 by using the exposure mask 5 in which the plurality of exposure masks 51 to 54 for forming the drive electrodes 12 are joined to each other at the joint region 55 (see FIG. 6 and FIG. 7).

Next, the transparent substrate film 13 and the transparent substrate film 14 are laminated to each other such that the detection electrodes 11 and the drive electrodes 12 intersect with each other (see FIG. 3). Here, the transparent substrate film 13 and the transparent substrate film 14 are laminated to each other such that the joint regions 15, 16 of the transparent substrate film 13 where the detection electrodes 11 are not arranged corresponding to the joint region 35 do not overlap, partially or wholly, with the joint regions 17, 18 of the transparent substrate film 14 where the drive electrodes 12 are not arranged corresponding to the joint region 55.

Due to such a constitution, even in manufacturing a large-sized touch panel such as an electronic board, by performing exposure with inexpensive small-sized exposure masks joining to each other, it is possible to largely decrease a manufacturing cost. In this case, the input device can be manufactured by reducing a manufacturing cost while maintaining the visibility of the display screen.

### 1-3. Effects and the Like

As has been described heretofore, in this embodiment, the input device 1 includes the transparent substrate film 13, the transparent substrate film 14, and the control unit 10. The plurality of detection electrodes 11 are arranged on the transparent substrate film 13. The plurality of drive electrodes 12 are arranged on the transparent substrate film 14 so that the drive electrodes 12 intersect with the detection electrodes 11. The transparent substrate film 14 is coupled to the transparent substrate film 13 with the transparent substrate films 13, 14 overlapping with each other. The control unit 10 is configured to detect electrostatic capacitance between the detection electrodes 11 and the drive electrodes 12 to detect coordinates of touch points on the transparent substrate films 13, 14 which are coupled to each other. The transparent substrate film 13 includes the joint regions 15, 16 on which the detection electrodes 11 are not arranged, and the plurality of regions 13a to 13d into which a whole region of the transparent substrate film 13 is segmented by the joint regions 15, 16, each segmented region having the plurality of detection electrodes 11 arranged thereon. The transparent substrate film 14 includes the joint regions 17, 18 on which the drive electrode 12 is not arranged, and the plurality of regions 15a to 15d into which a whole region of the transparent substrate film 14 is segmented by the joint regions 17, 18, each segmented region having the plurality of drive electrodes 12 are arranged thereon. On the coupled transparent substrate films 13, 14, the joint regions 15 to 18 are arranged such that the joint regions 15, 16 and the joint regions 17, 18 do not overlap with each other partially or wholly.

Due to the above-mentioned constitution, the detection electrodes 11 or the drive electrodes 12 can be formed for the respective regions 13a to 13d, 14a to 14d which are partitioned by the joint regions 15 to 18 in the respective transparent substrate films 13, 14 and hence, a large-sized touch panel can be easily manufactured. The touch panel can be manufactured by joining the small-sized exposure masks to each other and hence, a manufacturing cost can be reduced without using a one-sheet-type expensive exposure mask having the substantially same size as a touch panel screen. Further, the joint regions 15, 16 of the transparent substrate film 13 and the joint regions 18, 17 of the transparent substrate film 14 do not overlap with each other and hence, non-uniformity of the electrode pattern can be made inconspicuous.

In this embodiment, the liquid crystal display device includes the input device 1 and the display unit 2. The display unit 2 includes the display screen 21 to display an image. The transparent substrate films 13, 14 of the input device 1 are joined to the display unit 2 in a state where the transparent substrate films 13, 14 overlap with the display screen 21.

Due to the above-mentioned constitution, the joint regions 15, 16 of the transparent substrate film 13 overlap with the drive electrodes 12, and the joint regions 18, 17 of the transparent substrate film 14 overlap with the detection electrodes 11 and hence, the deterioration of visibility of the display screen 21 attributed to non-uniformity of the electrode pattern can be suppressed.

### Second Embodiment

In the first embodiment, the electrode pattern of the detection electrodes and the electrode pattern of the drive electrodes are formed using one sheet of exposure mask which is formed by joining the plurality of exposure masks respectively. In the second embodiment, one sheet of transparent substrate film is formed by joining a plurality of transparent substrate films for forming electrodes to each other.

Hereinafter, an input device according to this embodiment is described while omitting the description with respect to the constitution and the manner of operation of the input device according to the second embodiment, which are substantially equal to those of the input device 1 according to the first embodiment when appropriate.

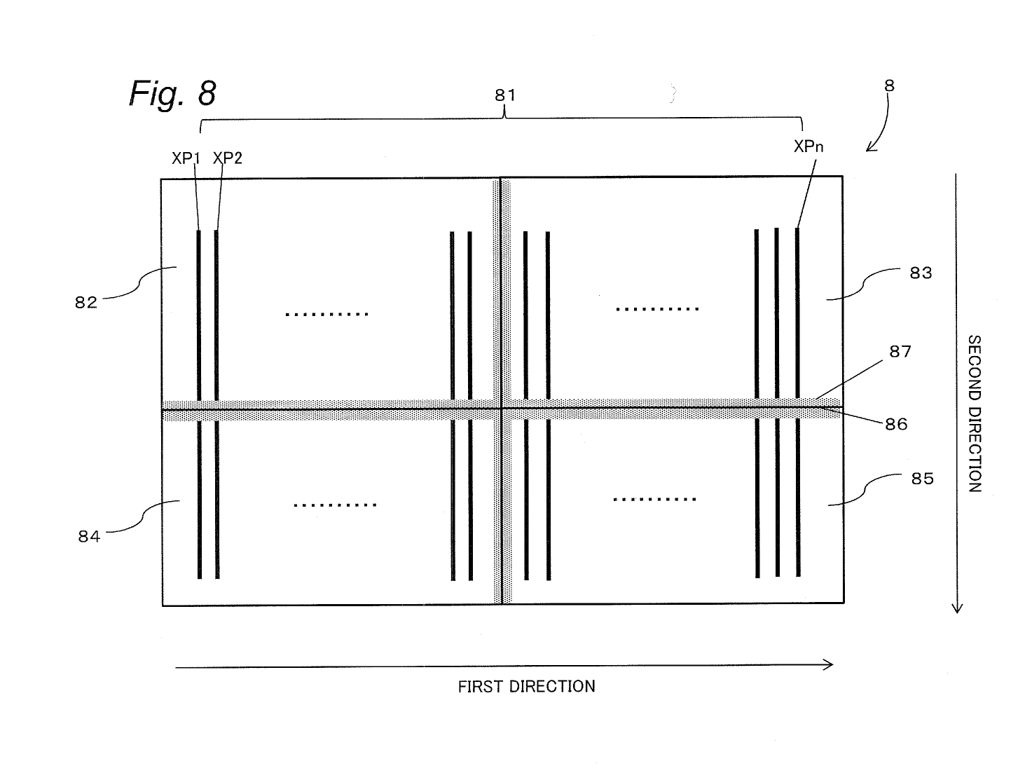

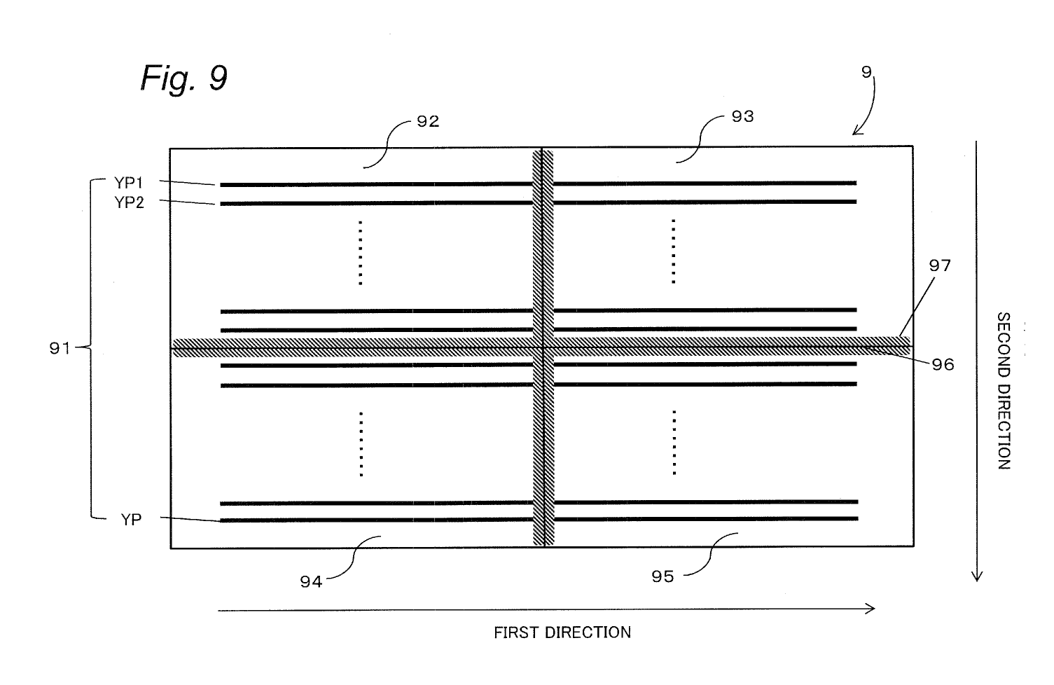

FIG. 8 is a view showing one example of a transparent substrate film having drive electrodes according to the second embodiment. FIG. 9 is a view showing one example of a transparent substrate film having detection electrodes according to the second embodiment.

In this embodiment, the transparent substrate film 8 on which detection electrodes 81 are arranged is, as shown in FIG. 8, constituted of four transparent substrate films 82 to 85. On four transparent substrate films 82 to 85, the plurality of detection electrodes 81 are arranged respectively. The detection electrodes 81 are formed individually on four transparent substrate films 82 to 85 respectively by using a photolithography method or the like. The transparent substrate films 82 to 85 are joined with each other at a joint portion 86, thus forming one sheet of the transparent substrate film 8. A region 87 at the joint portion 86 is one example of a first joint region.

In this embodiment, the transparent substrate film 9 on which drive electrodes 91 are arranged is, as shown in FIG. 9, constituted of four transparent substrate films 92 to 95. On four transparent substrate films 92 to 95, the plurality of drive electrodes 91 are arranged respectively. The drive electrodes 91 are formed individually on four transparent substrate films 92 to 95 respectively by using a photolithography method or the like. The transparent substrate films 92 to 95 are joined to each other at a joint portion 96, thus forming one sheet of the transparent substrate film 9. A region 97 at the joint portion 96 is one example of a second joint region.

The joint portions 86, 96 are formed by injecting a transparent resin, for example. As a transparent resin material of the joint portions 86, 96, for example, a transparent resin film, a transparent resin plate or the like made of polycarbonate, acrylic, polyethylene terephthalate, triacetylcellulose or the like can be used.

As a material of the detection electrodes 81, and the drive electrodes 91 includes, in the same manner as the first embodiment, a metal film or the like made of silver, copper, aluminum, gold, nickel, stainless copper or the like for example. Further, a conductive paste material, a carbon paste material or the like containing fine particles of the above-mentioned metals may be used as a material of the detection electrode 81 and the drive electrode 91.

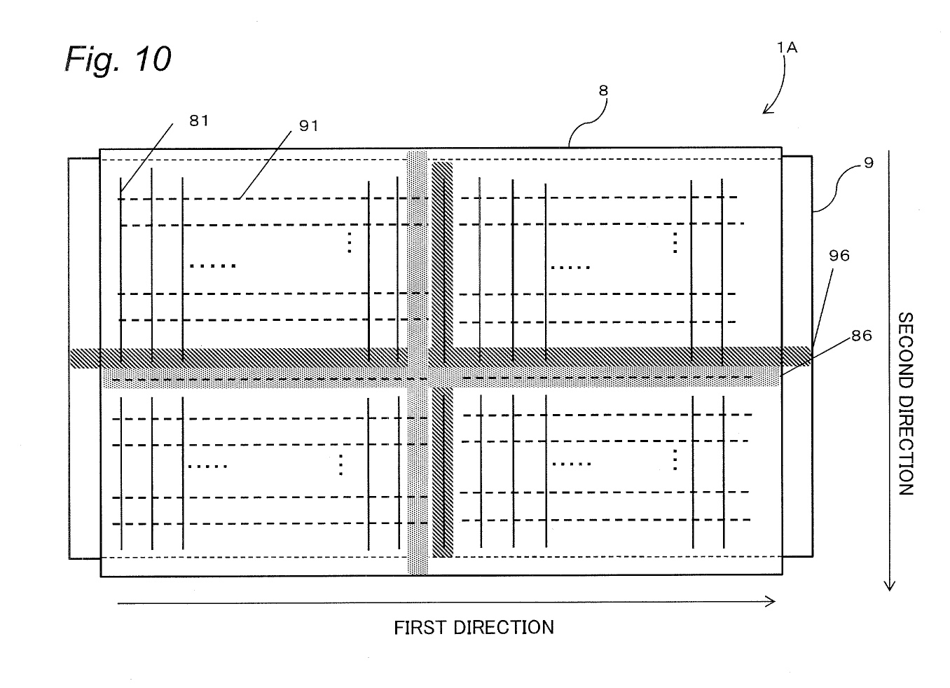

FIG. 10 is a view for describing an electrode arrangement in an input device 1A. The input device 1A according to this embodiment is, as shown in FIG. 10, constituted by laminating the transparent substrate film 8 and the transparent substrate film 9 to each other. The joint portion 86 of the transparent substrate film 8 and the joint portion 96 of the transparent substrate film 9 are arranged at the position where the joint portion 86 and the joint portion 96 do not overlap with each other. The joint portion 86 and the joint portion 96 are made of a transparent resin and hence, edges of the respective transparent substrate films 82 to 85, 92 to 95 are minimally viewed from a user.

As described above, in the input device 1A of this embodiment, as shown in FIG. 8, the transparent substrate film 8 is formed by joining the plurality of transparent substrate films 82 to 85 on which the plurality of detection electrodes 81 are arranged respectively to each other along the region 87 of the joint portion 86. As shown in FIG. 9, the transparent substrate film 9 is formed by joining the plurality of transparent substrate films 92 to 95 on which the plurality of drive electrodes 91 are arranged respectively to each other along the region 97 of the joint portion 96.

Due to the above-mentioned constitution, the transparent substrate film can be manufactured by joining the plurality of electrode substrates and hence, a manufacturing cost of the touch panel can be reduced without using an expensive exposure mask having the substantially same size as a touch panel screen. The electrodes can be formed by using an exposure device for every electrode substrate to be joined and hence, a manufacturing cost can be reduced. Further, according to this embodiment, it is possible to obtain an advantageous effect that a large-sized touch panel which cannot be handled by a conventional film manufacturing device can be realized.

### Other Embodiments

As described above, the first and second embodiments have been described as examples of the techniques disclosed by this application. However, the techniques according to the present disclosure are not limited to the first and second embodiments, and are also applicable to an embodiment to which changes, replacements, additions, omissions and the like are made. Further, novel embodiments are also conceivable by combining the respective constitutional elements described in the above-mentioned first and second embodiments.

Accordingly, other embodiments are exemplified hereinafter.

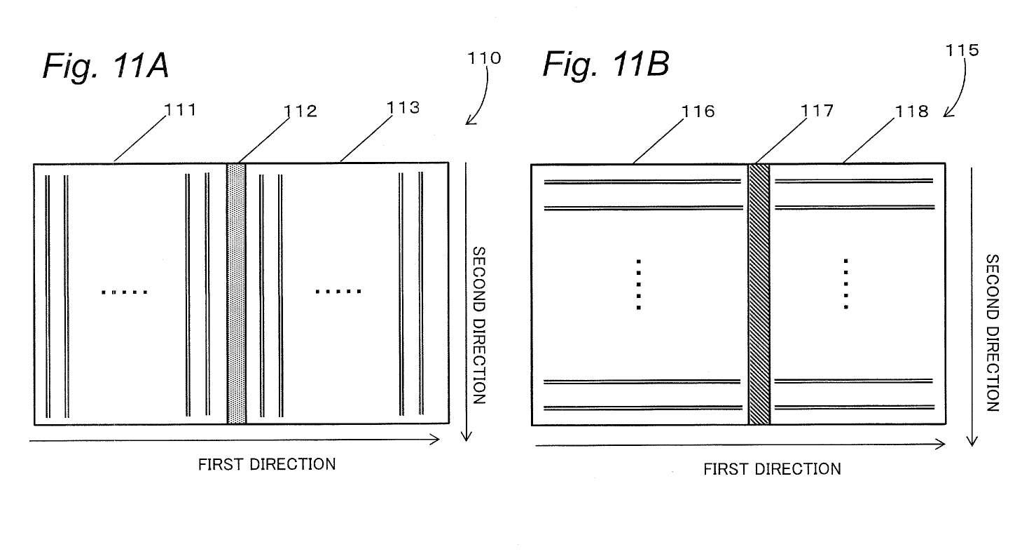

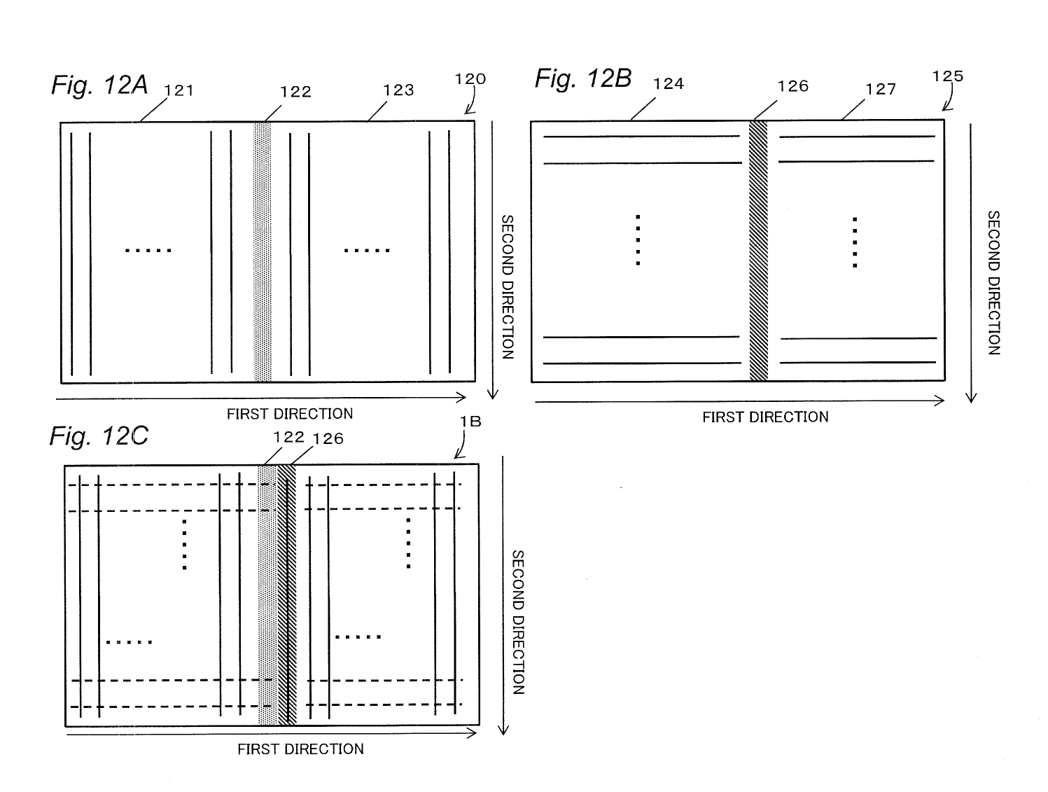

In the first embodiment, the detection electrodes and the drive electrodes are formed by using one sheet of exposure mask which is formed by joining four exposure masks with each other. However, the number of exposure masks for constituting one sheet of exposure mask is not limited to four. One sheet of exposure mask may be formed by joining arbitrary number of exposure masks to each other. Hereinafter, other embodiments are described hereinafter with reference to FIG. 11A to 11B and FIG. 12A to 12C.

FIG. 11A and 11B show an example that one sheet of exposure mask is formed by joining two exposure masks with each other. FIG. 11A shows an exposure mask 110 for detection electrodes which is formed by joining two exposure masks 111, 113 with each other at a joint region 112. Further, FIG. 11B shows an exposure mask 115 for drive electrodes which is formed by joining two exposure masks 116, 118 with each other at a joint portion 117.

FIG. 12A shows a transparent substrate film 120 on which detection electrodes are formed by using an exposure mask 110 for detection electrodes shown in FIG. 11A. FIG. 12B shows a transparent substrate film 125 on which drive electrodes are formed by using the exposure mask 115 for drive electrodes shown in FIG. 11B.

As shown in FIG. 12A, the transparent substrate film 120 has regions 121, 123 where the detection electrodes are arranged, and a joint region 122 where detection electrodes are not arranged. Further, as shown in FIG. 12B, the transparent substrate film 125 has regions 124, 127 where the drive electrodes are arranged, and a joint region 126 where the drive electrode is not arranged.

FIG. 12C shows an input device 1B which is constituted by laminating the transparent substrate film 120 shown in FIG. 12A and the transparent substrate film 125 shown in FIG. 12B to each other. As shown in FIG. 12C, the joint region 122 and the joint region 126 are located on positions where the joint region 122 and the joint region 126 do not overlap with each other as a whole in the first direction.

In the second embodiment, with respect to the detection electrode pattern and the drive electrode pattern, one sheet of transparent substrate film is formed by joining four transparent substrate films on which electrodes are formed respectively with each other. However, the number of transparent substrate films to be joined to each other is not limited to four. For example, in the same manner as an example shown in FIG. 12, one sheet of transparent substrate film may be formed by two transparent substrate films.

Further, in the first and second embodiments, a width of the joint region may be set within two times as large as an arrangement pitch of the drive electrodes or an arrangement pitch of the detection electrodes, for example. Due to such a constitution, non-uniformity attributed to the joint portions of the exposure masks or the joint portions of the electrode substrate films can be made inconspicuous and simultaneously, the touch performance of the touch panel can be ensured. Further, a width of a portion corresponding to the joint region where the electrodes are not arranged may be set equal to the arrangement pitch of the drive electrodes or the arrangement pitch of the detection electrodes.

In the first and second embodiments, the detection electrodes 11 and the drive electrodes 12 are formed of metallic fine wires. However, the detection electrodes 11 and the drive electrodes 12 may be formed in mesh shapes. The mesh shapes may have regular pattern of the mesh arrangement or random pattern of the mesh arrangement.

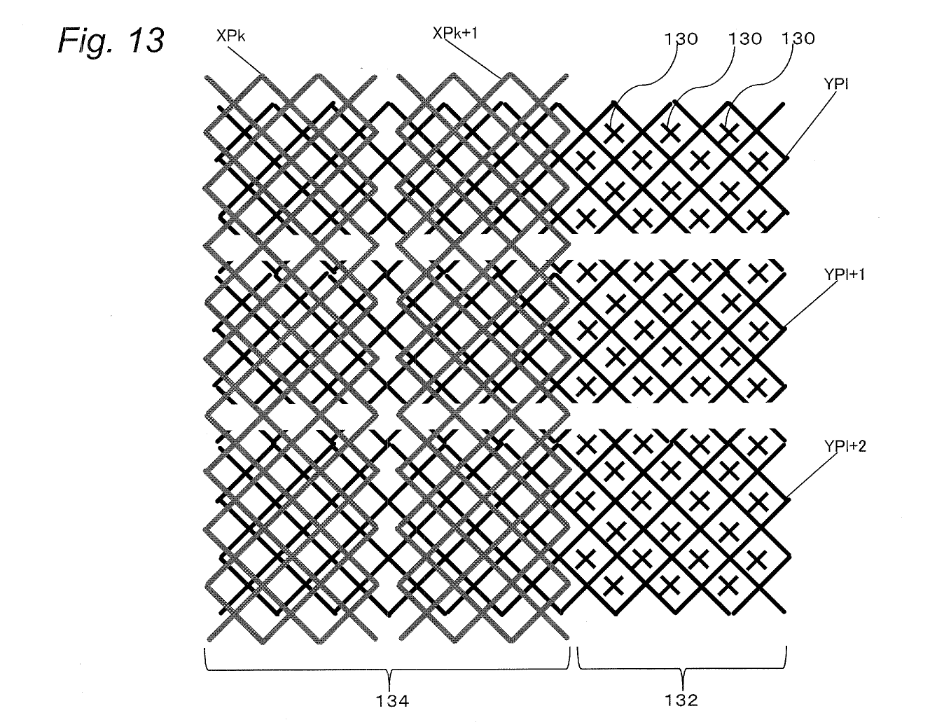

In the first and second embodiments, only the detection electrodes 11 or only the drive electrodes 12 are formed in a region of one transparent substrate which overlaps with a joint region of the other transparent substrate. However, dummy electrodes may be provided in addition to the detection electrodes 11 or the drive electrodes 12 in the region. Hereinafter, such a constitution is described with reference to FIG. 13.

FIG. 13 shows dummy electrodes formed in a region on a transparent substrate which overlaps with a joint region. A detection electrode XPk and a drive electrode YP1 are formed in a rectangular mesh-shaped pattern respectively. In a region 132 on the transparent substrate which overlaps with a joint region on a detection electrode XPk side, dummy electrodes 130 are formed together with drive electrodes YP1. In a region 134 on the transparent substrate which overlaps with the detection electrode XPk, the dummy electrodes 130 are not formed, and only the drive electrodes YP1 are formed. Due to an electrode pattern of the dummy electrodes 130 shown in FIG. 13, the dummy electrodes 130 are insulated from the drive electrode YP1.

By displacing the joint regions from each other, non-uniformity attributed to the joint portions of the exposure masks or the joint portions of the electrode substrate films can be made inconspicuous. Further, by adding the dummy electrode 130, non-uniformity can be made more inconspicuous.

In the first and second embodiments, as the first and second transparent substrates, the transparent substrate film formed of a transparent resin film is used. However, as the first and second transparent substrates, a transparent resin film may not be used. For example, the first and second transparent substrates may be formed of a glass substrate. Further, in the first and second embodiments, the detection electrodes 11 and drive electrodes 12 are respectively arranged on one of the two transparent substrate films, however, the detection electrodes 11 and drive electrodes 12 are respectively arranged on one of both principle surfaces of one transparent substrate film. For example, by using the exposure mask 3 for detection electrodes, the detection electrodes 11 are formed on one principal surface of the transparent substrate film, and by using the exposure mask 5 for drive electrodes, the drive electrodes 12 are formed on the other principal surface of the transparent substrate film such that the joint regions 15, 17 and joint regions 16, 18 do not overlaps with each other. Accordingly, by setting the position of each electrode and the joint regions on one transparent substrate film without the adjustment of laminating position of the two transparent substrate films, a manufacturing cost can be reduced.

In the first and second embodiments, the input device is arranged on a user side of the display unit. However, the input device may not be arranged on the display unit from the outside. The input device may be constituted integrally with the display unit, and may be incorporated into the inside of the display unit, for example.

In the first and second embodiments, the liquid crystal display is used as the display unit. However, the display unit may not be a liquid crystal display. For example, the display unit may be an organic EL display, an LED display, or an electronic paper display.

### INDUSTRIAL APPLICABILITY

The input device and the display device according to present disclosure are applicable to a display device which is used with an input device such as an electronic board in an integral manner.

What is claimed is:

1. An input device comprising:
a first transparent substrate on which a plurality of first electrodes are arranged;
a second transparent substrate on which a plurality of second electrodes arranged so that the second electrodes intersect with the first electrodes, the second transparent substrate being coupled to the first transparent substrate with the first and second transparent substrates overlapping each other; and
a control unit configured to detect electrostatic capacitance between the first and second electrodes to detect coordinates of touch points on the first and second transparent substrates coupled to each other, wherein
the first transparent substrate includes a first joint region on which the first electrodes are not arranged and a plurality of regions into which a whole region of the first transparent substrate is segmented by the first joint region, each segmented region having the plurality of first electrodes arranged thereon,
the second transparent substrate includes a second joint region on which the second electrodes are not arranged and a plurality of regions into which a whole region of the second transparent substrate is segmented by the second joint region, each segmented region having the plurality of second electrodes arranged thereon, and
on the coupled first and second transparent substrates, the first and second joint regions are arranged such that the first joint region and the second joint region do not overlap with each other partially or wholly.

2. The input device according to claim 1, wherein
the plurality of first electrodes are arranged in parallel in a first direction,
the plurality of second electrodes are arranged in parallel in a second direction which intersects with the first direction,
each of the first and second joint regions includes
a region which extends in the first direction, and
a region which extends in the second region, wherein
the regions which extend in the first direction in the first and second joint regions do not overlap with each other, and the regions which extend in the second direction in the first and second joint regions do not overlap with each other.

3. The input device according to claim 1, wherein
the plurality of first electrodes arranged on the first transparent substrate are formed by using a first exposure mask formed by joining a plurality of exposure masks at an interval corresponding to the first joint region, and
the plurality of second electrodes arranged on the second transparent substrate are formed by using a second exposure mask formed by joining a plurality of exposure masks at an interval corresponding to the second joint region.

4. The input device according to claim 1, wherein
the first transparent substrate is formed by joining a plurality of transparent substrates on which the plurality of first electrodes are arranged along the first joint region, and
the second transparent substrate is formed by joining a plurality of transparent substrates on which the plurality of second electrodes are arranged along the second joint region.

5. The input device according to claim 1, wherein
a dummy electrode is arranged in at least one of a region on the first transparent substrate, which faces the second joint region and a region on the second transparent substrate, which faces the first joint region, and
the dummy electrode is insulated from the first electrodes and the second electrodes.

6. The input device according to claim 1, wherein
the first and second electrodes have a meshed shape.

7. The input device according to claim 1, wherein
first and second transparent substrates have film shapes.

8. A display device comprising:
the input device according to claim 1; and
a display unit having a display screen to display an image is displayed, wherein
the first and second transparent substrates of the input device are joined to the display unit such that the first and second transparent substrates overlap with the display screen.

9. A method of manufacturing an input device comprising:
forming a plurality of first electrodes on a first transparent substrate by using a first exposure mask formed by joining a plurality of exposure masks on a first joint portion;
forming a plurality of second electrodes on a second transparent substrate by using a second exposure mask formed by joining a plurality of exposure masks at a second joint portion; and
laminating the first transparent substrate and the second substrate to each other with the first electrodes intersecting with the second electrodes, wherein
in the laminating the first transparent substrate and the second transparent substrate,
the first transparent substrate and the second transparent substrate are laminated to each other so that a first joint region where the first electrodes are not arranged corresponding to the first joint portion on the first transparent substrate does not overlap, partially or wholly, with a second joint region where the second electrodes are not arranged corresponding to the second joint portion on the second transparent substrate.
